(19) United States
(12) Patent Application Publication
(10) Pub. No.: US 2016/0140851 A1
(43) Pub. Date: May 19, 2016

(54) SYSTEMS AND METHODS FOR DRONE NAVIGATION

(71) Applicants: Ziv LEVY, Alon-HaGalil (IL); Ran LEVY, Reut (IL)

(72) Inventors: Ziv LEVY, Alon-HaGalil (IL); Ran LEVY, Reut (IL)

(21) Appl. No.: 14/882,575

(22) Filed: Oct. 14, 2015

Related U.S. Application Data
(60) Provisional application No. 62/081,092, filed on Nov. 18, 2014.

(51) Int. Cl. G08G 5/00; G01C 21/00; B64C 39/02; B64D 47/08

(52) U.S. Cl. CPC G08G 5/0069; G08G 5/0034; G08G 5/0039; B64D 47/08; G01C 21/005; B64C 39/024; B64C 2201/127

(57) ABSTRACT

There is provided a method for navigation of a drone through a geographical air space, comprising: identifying a drone within or in proximity to a geographical air space; receiving flight data representing a certain flight path through the geographical air space; evaluating the flight data based on a flight risk map to determine the flight risk through the geographical air space, wherein the flight risk map includes zones, each zone being associated with a certain flight safety score; and one or more of: approving the certain flight path when the flight risk of the drone is within an acceptable risk threshold, blocking the certain flight path when the flight risk of the drone is outside the acceptable risk threshold, and obtaining external control of navigation of the drone to navigate the drone through at least one zone having the acceptable risk threshold.

### RELATED APPLICATION

This application claims the benefit of priority under 35 USC 119(e) of U.S. Provisional Patent Application No. 62/081,092 filed on Nov. 18, 2014, the contents of which are incorporated herein by reference in their entirety.

### BACKGROUND

The present invention, in some embodiments thereof, relates to systems and methods for drone navigation and, more specifically, but not exclusively, to systems and methods for remote drone navigation and/or control.

Drones are air vehicles without a human pilot. Drone may fly autonomously, controlled by onboard computers, or may fly under remote human pilot control.

Commercial drone development activity is being pursued by businesses, entrepreneurs, and individuals. For example, drones are being developed to deliver small and lightweight packages directly to consumers.

### SUMMARY

According to an aspect of some embodiments of the present invention there is provided a computer implemented method for navigation of a drone through a geographical air space, the method comprising: identifying a drone within or in proximity to a geographical air space; receiving from the drone, flight data representing a certain flight path of the drone through the geographical air space; evaluating the flight data based on a flight risk map to determine the flight risk of the certain flight path of the drone through the geographical air space, wherein the flight risk map of the geographical air space includes zones, each zone being associated with a certain flight safety score; and at least one member of the group consisting of: approving the certain flight path when the flight risk of the drone is within an acceptable risk threshold, blocking the certain flight path when the flight risk of the drone is outside the acceptable risk threshold, and obtaining external control of navigation of the drone to navigate the drone through at least one zone having the acceptable risk threshold.

Optionally, the method further comprises acquiring automatic or manual control of the drone by a local drone control server; and navigating the drone within the geographical air space based on the evaluated flight path.

Optionally, the method further comprises generating a flight plan for the drone within the acceptable risk threshold based on the evaluated flight data, and navigating the drone within the geographical air space based on the generated flight plan.

Optionally, the method further comprises monitoring flight data of the drone during flight within the geographical air space, and iterating the evaluation based on dynamic changes of at least one of the flight data and the flight risk map.

Optionally, the method further comprises restricting navigation of the drone to within certain regions of the geographical air space based on the flight risk map, to maintain the drone within zones of the geographical air space having an acceptable flight risk defined by a risk threshold.

Optionally, the method further comprises receiving details of a requested route from at least one of the drone and a ground based drone operator; calculating at least one flight route through the geographical air space based on the flight risk map, the at least one flight route calculated to have a total low risk of flight based on the flight safety scores of respective zones of the geographical air space; comparing the total low risk of flight to a predefined total risk threshold to designate a subset of at least one flight route with acceptable total flight risk; and selecting an optimal route from the subset based on a optimization of total flight risk and total flight length.

Optionally, the method further comprises receiving details of a flight plan from at least one of the drone and a ground based drone operator; calculating a total risk of flight of the flight plan through the geographical air space based on the flight risk map, the total risk of flight calculated based on the flight safety scores of respective zones of the geographical air space within the flight plan; comparing the total low risk of the flight plan to a predefined total risk threshold to approve or deny the flight plan; and providing an alternative calculated flight route having a total risk below the threshold, when the flight plan is denied.

According to an aspect of some embodiments of the present invention there is provided a system for navigation of a drone through a geographical air space, the system comprising: a drone communication interface configured to transmit data to at least one drone and receive data transmitted by the at least one drone; a central drone control server in communication with the drone interface, the server configured to: identify a drone within or in proximity to a geographical air space; receive from the drone, flight data representing a certain flight path of the drone through the geographical air space; evaluate the flight data based on a flight risk map to determine the flight risk of the certain flight path of the drone through the geographical air space, wherein the flight risk map of the geographical air space includes zones, each zone being associated with a certain flight safety score; and performing at least one member of the group consisting of: send a message to the drone indicating approval of the certain flight path when the flight risk of the drone is within an acceptable risk threshold, send the message to the drone indicating blockage of the certain flight path when the flight risk of the drone is outside the acceptable risk threshold, and obtain external control of navigation of the drone to navigate the drone through at least one zone having the acceptable risk threshold.

Optionally, the system further comprises a server interface configured for installation on the at least one drone and to transmit data to the server and receive data transmitted by the server; a drone module configured for installation on the at least one drone, the drone module in communication with the server interface, the drone module configured to generate flight data of the drone through the geographical air space.

Optionally, the drone module is configured to relinquish navigation of the drone to the central server.

Optionally, the central server controls the navigation of the drone by transmitting and receiving within a predefined frequency band.

Optionally, the central drone control server further comprises a registration module configured to receive registration data of a new drone and store the registration data, the registration data including at least one of: a unique identifier and drone performance data.

Optionally, the system further comprises a flight monitoring module in communication with the control server, the flight monitoring module configured to: calculate a flight vector path of the drone based on the flight data; estimate the flight of the drone based on the flight vector to determine when the drone is estimated to fly into a certain zone having an unacceptable risk level above a threshold; and send a command to the drone to at least one of: hover in place, perform an emergency landing, and to change direction to remain within at least one zone having an acceptable risk level below the threshold.

Optionally, the system further comprises a communication loss module for installation on the drone, the communication loss module configured to: receive a communication-loss flight plan to execute when communication has been lost; monitor for messages transmitted by the control server; and execute the communication-loss flight plan when messages transmitted by the control server have not been received after a predefined period of time.

Optionally, the system further comprises a collision prevention module in communication with the control server, the collision prevention module configured to: receive flight plans of drones; identify a risk of collision between at least two of the drones; and generate a message indicating the risk of collision and trigger adjustment of at least one of the flight plans of the at least two of the drones to reduce or prevent the risk of collision. Optionally, the collision prevent module is further configured to calculate an estimated drone location when communication with one or more drones has been lost, the estimated drone location including a margin of safety around the predicted location.

Optionally, the system further comprises a damage reduction module in communication with the control server, the data reduction module configured to: identify a scenario of unavoidable drone loss; plan a reduced damage route to land the drone while minimizing damage based on navigating the drone through low risk zones; and navigate the drone through the reduced damage route until the drone lands.

According to an aspect of some embodiments of the present invention there is provided a computer implemented method for generating a flight risk map of a geographical air space for navigation of a drone through the geographical air space, the method comprising: generating a model dividing a geographical air space into zones; assigning a certain flight safety score to each respective zone of the zones in the model, the certain flight safety score designated from flight safety scores based on at least one object within the respective zone and a set of rules mapping the at least one object to the certain flight safety score; monitoring for dynamic changes to at least one of the set of rules and the at least one object; updating at least one of the set of rules and the at least one object; repeating the generating and the assigning; and outputting a dynamically updated flight map based on the model.

Optionally, the set of rules includes designating respective zones containing at least one object impermeable to flight as an impossible flight score.

Optionally, the set of rules includes designating respective zones containing prohibited drone flight regions as the impossible flight score.

Optionally, the set of rules includes designating respective zones containing at least one dynamic object based on respective risk of flying introduced by the at least one dynamic object. Optionally, the at least one dynamic object is selected from the group consisting of: weather conditions, air traffic, changes in flight policy, event in a park, a construction zone, and a hot air balloon flying zone.

Optionally, the set of rules includes designating respective zones containing at least one static object based on respective risk of flying into the at least one static object. Optionally, the at least one static object includes at least one member selected from the group consisting of: high rise buildings, flammable commercial warehouse, and power lines.

Optionally, the system further comprises designating at least one as a camera prohibited zone based on the set of rules defining the at least one object as a photography prohibited object.

Optionally, the dynamically changed is based on time of day.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic diagram depicting drone navigation in an environmental context, in accordance with some embodiments of the present invention;

FIG. 2 is a flowchart of a computer implemented method for generating a flight risk map, in accordance with some embodiments of the present invention;

FIG. 3A is a block diagram of a high level system architecture to implement a central control server for navigation of drones and/or map server for generation o the flight risk map, in accordance with some embodiments of the present invention;

FIG. 3B is an example of system architecture to implement the central control server, in accordance with some embodiments of the present invention;

FIG. 4 is a flowchart of a computer implemented method for safe navigation of drones through designated zones based on a flight risk map, in accordance with some embodiments of the present invention;

FIG. 5 is a flowchart of a computer implemented method for analyzing drone flight details based on the flight risk map, in accordance with some embodiments of the present invention;

FIG. 6 is a computer implemented method for monitoring flight of a drone through a geographical air space based on a flight risk map, in accordance with some embodiments of the present invention; and

FIG. 7 is a flowchart of a computerized method for emergency and/or accident preventive procedures for the flying drone, in accordance with some embodiments of the present invention.

### DETAILED DESCRIPTION

The present invention, in some embodiments thereof, relates to systems and methods for drone navigation and, more specifically, but not exclusively, to systems and methods for remote drone navigation and/or control.

An aspect of some embodiments of the present invention relates to systems and methods for safe navigation of a drone through a geographical air space, the navigation of the drone based on flight through regions of the geographical air space designated as having an acceptable flight risk. A flight risk map associates a representation of the geographical air space with local flight risk scores based on the risk of flying the drone through the local air space. The flight risk map is optionally dynamically updated with dynamic and/or static conditions affecting the risk of flying the drone through respective local air spaces. The systems and/or methods prevent or reduce the risk of drones crashing into other objects (e.g., planes, other drones, buildings, hills, and power lines) by proactively preventing from the drones from flying above certain areas using the flight risk map. The systems and/or methods may imply proactive measures such as dynamic flight border control or centralized flight control that can accelerate the integration of civil unmanned aircraft systems into the national airspace system.

Optionally, the flight risk map is dynamically updated with changing conditions on the ground and/or in the air affecting the risk of flying through the local air space. For example, a hot air balloon festival in a local park, an air show over a city, construction activity involving high cranes, construction of new high rise buildings, police helicopter chases, and weather (e.g., storms, and/or strong winds). A new flight plan is dynamically generated based on the dynamically updated flight risk map, to prevent the drone from flying through local air spaces with dynamically changed risk profiles. Air spaces that have been previously designated as safe for flying may now have a risk that is too high for flying of the drone, for example due to weather (e.g., strong winds, hail), ground fire, a terrorist attack, and/or closure of air space. The drone is provided with the new flight plan for navigation within the geographical air space based on the new flight plan.

Optionally, a complete flight plan is calculated for the drone based on the cumulative flight risk over the entire flight path. The cumulative risk may be defined based on a cumulative risk threshold. The complete flight plan may be uploaded to the drone, or the drone may be controlled to fly via the flight plan.

A central server monitors and/or controls drones flying or attempting to fly through the geographical air space. The central server analyzes flight data of the drone to determine whether or not the drone is expected to fly through a local air space having a high risk of flight or through a prohibited local air space. Optionally, the central server monitors dynamic flight data of the drone to detect changes in the flight of the drone that may lead the drone to fly through the high risk or prohibited local air space.

The drone is equipped with an onboard module (e.g., software and/or hardware) to communicate with the central server, as described herein in additional detail. The module may be part of an operating system portion of a centralized controller that controls the drone. The module may be implemented as a part of a protocol that controls the drone. The module may allow the drone to relinquish navigation control over to the central server.

Optionally, the central server acquires control of the drone when the drone is flying through or estimated to fly through the high risk or prohibited air zone. The central server navigates the drone through the geographical air space via local air space regions having acceptable flight risk levels. The central server may directly control the drone, by a computer, or manually by a pilot. The central server may indirectly control the drone, by issuing flight instructions to the drone.

Alternatively or additionally, the central server restricts the flight of the drone to certain local air space regions, based on an acceptable flight risk within the local air space regions. The drone may be free to navigate autonomously within the designated local air space regions. The central server may monitor the drone based on calculated flight vectors to determine when the drone is expected to fly or has flown out of the designated local air space regions.

When the drone has flown or is expected to fly into a high risk region, the drone may be redirected back into the designated regions, instructed to perform an emergency landing, and/or instructed to hover.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

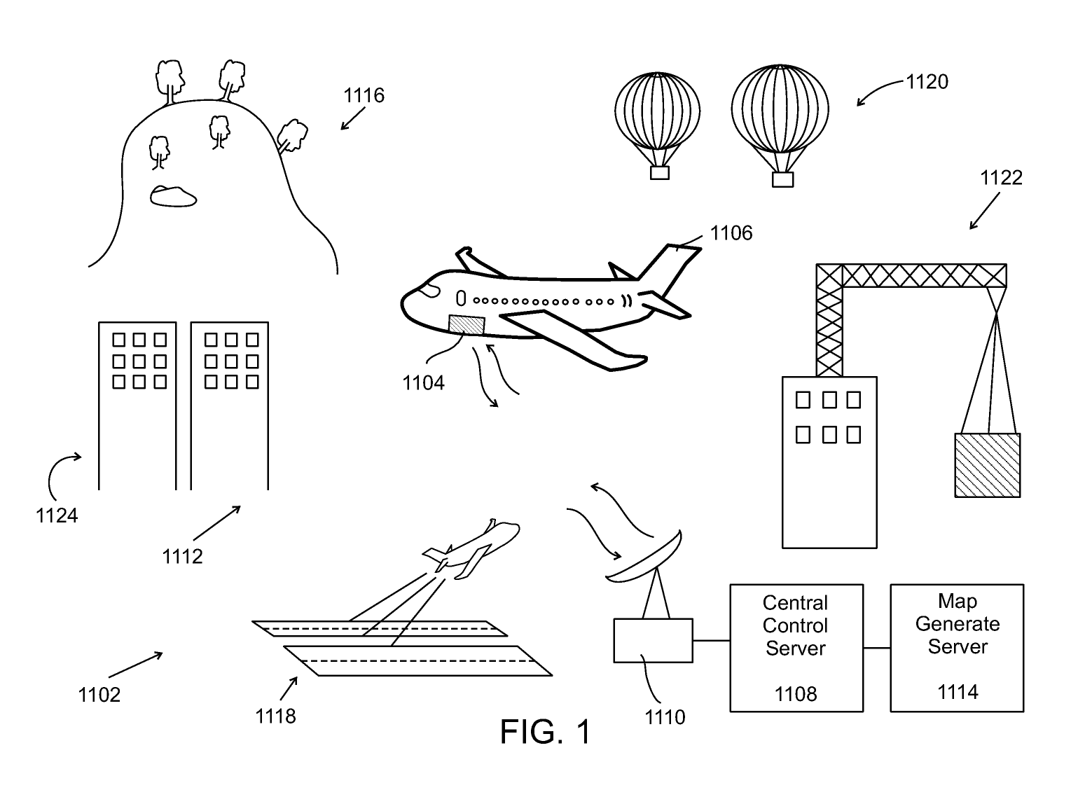

Reference is now made to FIG. 1, which is a schematic diagram depicting a drone navigation system and/or method in an environmental context, in accordance with some embodiments of the present invention. The drone navigation system navigates a drone through a geographical air space containing high fly risk zones, by navigating the drone through low fly risk zones.

The high and low flight risks may be predefined, for example, by the drone operator, based on local policy, and/or based on government policy. Low risk zones may be defined based on an acceptable risk of the drone crashing and/or causing damage to other property. High risk zones may be defined based on an unacceptable risk of the drone crashing and/or causing damage to other property. The low and high risk may be defined based on the properties of the air zone relative, as described herein, as opposed to, for example, risk of failure of the drone independently of surrounding conditions, for example, risk of manufacturing defect.

The systems and/or methods described herein provide for safe operation of drones in geographical environments containing high risk fly zones, for example, in urban areas, by directing the flight of the drone through designated low risk zones.

The systems and/or methods may be implemented by flight safety regulatory agencies to enforce drone flight policies, and/or to distribute policy updates in a timely manner.

Flight prevent measures are activated accordingly when the drone is not obeying navigation instructions based on the flight risk map. For example, the central controller takes control over navigation of the drone based on deviation from an allowed area defined by the flight risk map.

Drone navigation system 1102 includes a drone module 1104 for installation on a drone 1106, and a control center server 1108 that communicates with drone module 1104. Examples of drones 1106 include autonomous unmanned vehicles, which may include the ability to be manually remotely controlled by a pilot, for example, planes and helicopters. Drone module 1104 may be a software module installed on an onboard computer, a hardware module connected to the onboard computer, and/or a remote access module that communicates with a remote server storing program instruction for the functions described herein (e.g., accessed via a wireless link to the remote server). The hardware module may be a tamper proof box. Control center server 1108 may be implemented in a ground facility having wireless connectivity ability (e.g., antenna) for communicating with drone module 1104 while drone 1106 is airborne.

Drone module 1104 transmits flight data to control center 1108, and receives navigation data from control center 1108, for example, as described herein in additional detail.

Control center 1108 monitors and/or controls drones 1106 flying through a designated geographical air space 1112, for example, urban and/or rural areas. Control center 1108 performs one or more of the following functions: ensures that drones are certified to fly, automatically approves flight plans according to current policy and/or to specific urban limitations (based on a flight map), generates air routes that avoid obstacles (based on the flight map), monitors drones are flying within allowed air spaces (optionally based on enforcement of flight regulations), navigates drones through the allowed air spaces, acquires navigation control of the drone when the drone is not flying according to plan, provides the drones continuous anti-collision monitoring and/or control, and/or provides each drone with a contingency plan and/or emergency instructions (e.g., current emergency landing site, and current loss of radio control policy), for example, as described herein.

Drone module 1104 may communicate with central control server 1108 through a communication link, for example, a predefined frequency band selected based on the local geographical environment, a dedicated link, a public network (e.g., internet), a cellular link, and/or combinations thereof. Optionally, the communication is two way, where drone module 1104 and central control server 1108 are each able to transmit and receive data from each other. Optionally, the communication is encrypted. Attempts to alter and/or block messages may be interpreted by module 1104 and/or server 1108 as loss of communication.

Central control server 1108 includes or is in communication with a map generator server 1114 that generates a flight risk map of geographical air space 1112 containing flight risk region(s), for safe navigation of drone(s) 1106 through the geographical air space based on the flight map, for example, as described herein.

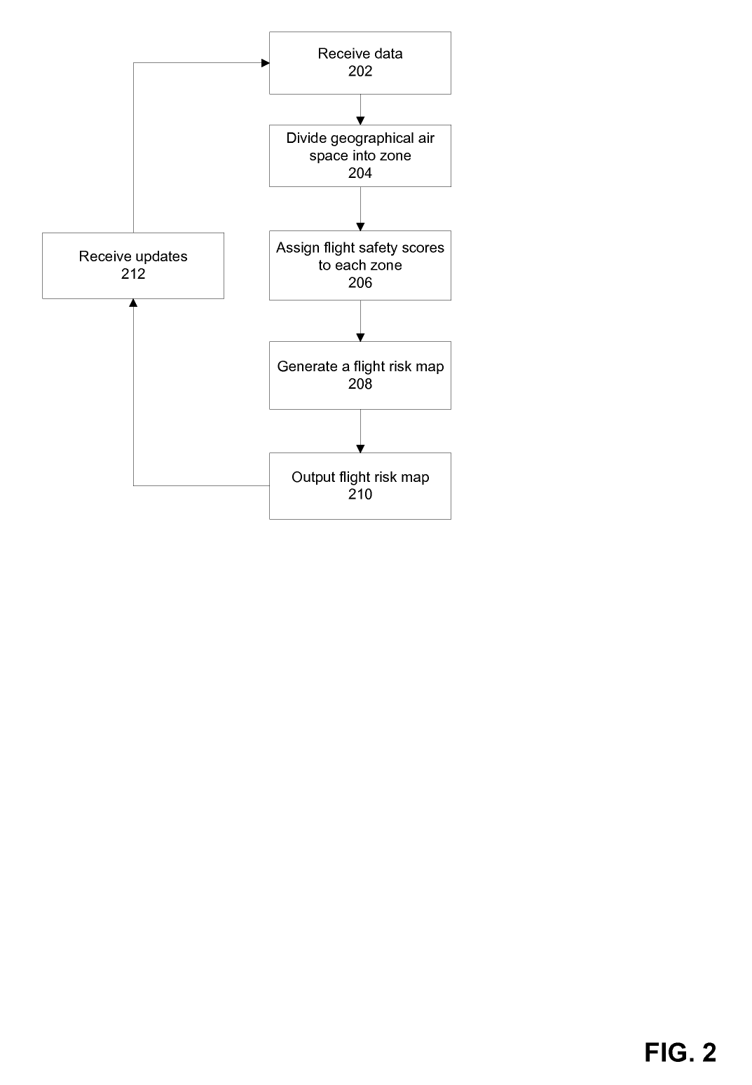

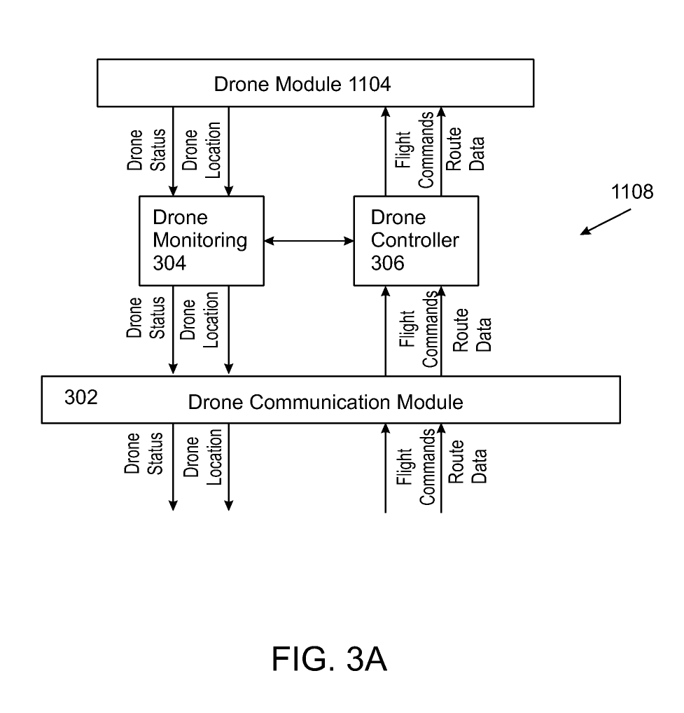

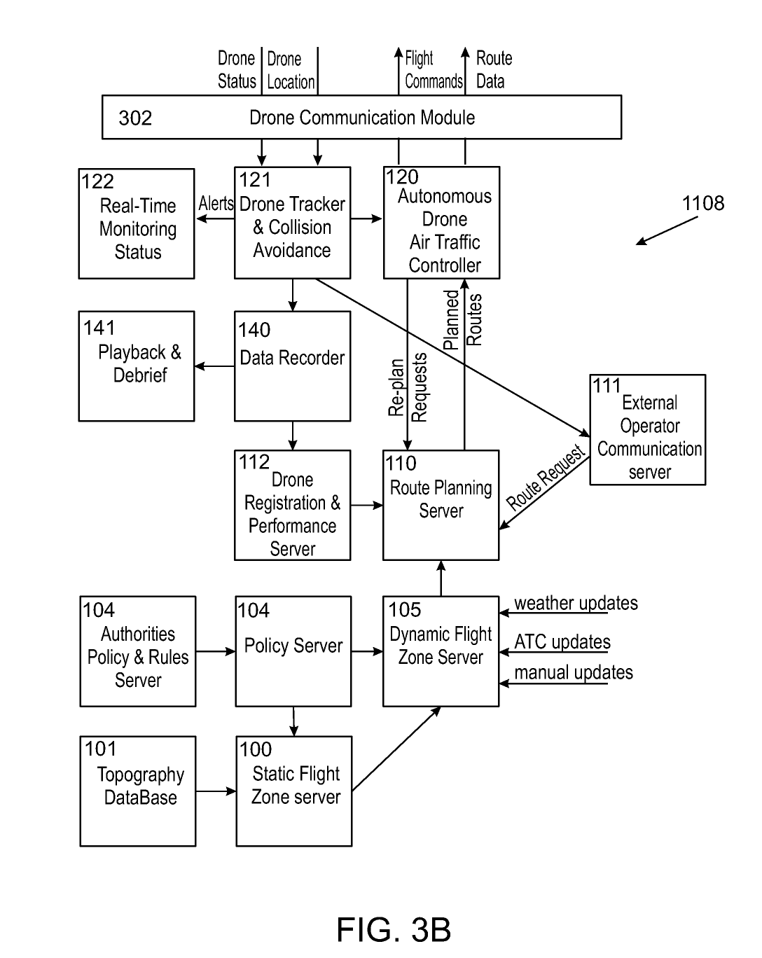

Reference is now made to FIG. 2, which is a flowchart of a computer implemented method for generating a flight risk map for a certain geographical air space, such as an urban region, for safe navigation of drone(s) through the geographical air space, in accordance with some embodiments of the present invention. Reference is also made to FIG. 1 for providing a schematic depiction of the geographical air space to help understand the flight risk map generation. Reference is also made to FIGS. 3A-3B, which are example of system architecture to implement central control server 1108 and/or map generator server 1114 of FIG. 1 in accordance with some embodiments of the present invention. FIG. 2 may be implemented by map generator server 1114. Map generator server 1114 may include modules 100, 101, 104, 104B, and/or 105, as described below.

FIG. 3B is a high level block diagram of an example of a system architecture to implement control server 1108. Drone module 1104 installed on the drone communicates with central control server 1108, for example, as described herein. Server 1108 may include or be in communication with a drone communication interface and/or module 302 that performs the air to ground communications, for example, as described herein. Server 1108 may include or be in communication with a drone monitoring module that optionally operates in real time, and tracks in-flight drone data, estimates flight parameters, and/or generates an alert when flight parameters are different than expected (e.g., when the drone is not following an approved flight plan), for example, as described herein. Server 1108 may include or be in communication with a drone controller module 306 that implements logic for controlling the drone in nominal flight, handling anomalies in the flight path, and/or handling emergency situations, for example, as described herein.

FIG. 3B is an example of a certain system design to implement control server 1108. Optionally, a real time monitoring station 122 in communication with control server 1108 enables human operators within the control center to view current and/or planned status, issue commands, and/or over ride automatic functions. Station 122 may include a display and/or user interface.

The method of FIG. 2 generates a three dimensional flight risk map. The map may cover the environmental air space available for drone flying. The map includes zones, each zone associated with risk of flying the drone through the respective zone.

Portions of the method of FIG. 2 may be implemented, for example, by a static flight zone server 100 that receives topography, infrastructure data, and/or other air space parameters, and generates flight zones, optionally according to policy, as described herein. Server 100 may define no-fly zones (e.g. impossible to fly there, such as through terrain) and/or prohibited fly zones (e.g., forbidden flight, such as over airports), as described herein. Server 100 may generate possible emergency landing sites, as described herein. Dynamic flight zone server 105 may provide additional functions in generating the flight zones and/or implementing portions of the method of FIG. 2, as described herein. Optionally, both static flight server 100 and dynamic flight server 105 operate together (independently, sequentially, and/or in synchronization) to generate light zones, as described herein.

Flight zones and landing sites are generated according to policy. The server repeats the calculation based on policy change and/or based on input database change.

At 202, data to generate the geographical air space is received. Data may be locally stored, and/or obtained by accessing one or more remote servers.

The data may include one or more of:
Topography data describing the terrain of the area designated to the respective central control server, for example, a county, a city, and/or certain dimensions on the group. The topography data includes, for example, data of mountains, canyons, hills, valleys, and rives. The topography data may be obtained from a topography database 101, for example, using a server that retrieves and/or saves topography data in a local data base. Database 101 may be updated periodically and/or based on input changes.
Infrastructure data describing objects on the ground (e.g., buildings and their use, roads, and electric lines) and/or aerial information (e.g., airline flight routes, and restricted flight spaces). The infrastructure data may be obtained from an infrastructure database, for example, using a server that retries and/or saves infrastructure data (on the ground and/or in the air) in a local data base. The infrastructure database may be updated periodically and/or based on input changes.
Policy rules, which may be specific to each national and municipal operator, relating infrastructure types to accepted risk levels. The policy rules may be obtained by a policy server 104 accessing, for example, an external authorization policy and rules server 104B, for example, a local server that retrieves and/or keeps track of policies that affect flight zones and/or routes from the remote server.

Optionally, dynamic updates of factors affecting zones are received. For example:
Weather, which may include current and/or forecasted weather conditions.
Air traffic control information, which may include current and/or planned air traffic information, for example, a police helicopter aerial pursuit in progress within a certain area of the town.
Other updates, which may be manually or automatically provided, such as: temporary changes in flight policy (e.g., temporary closure of a given air space due to an air show) or ground activity (e.g., a public event in a park, changing the risk level associated with this area due to children flying kites).

At 204, the geographical air space is divided into zones. Optionally, the zones are geometric volumes, for example, cubes. The zones may be uniform in size (e.g., each cube the same size) and/or may vary in size (e.g., each cube having a different size), for example, depending on a desired fly zone resolution, and/or depending on the density of different object types within the airspace. Alternatively or additionally, the geographic space is designated based on continuous and/or discrete functions, without necessarily distinct boundaries between zones.

The zones may be selected to include one type of object. The zones may be selected to include a dominant type of object, for example, when power lines exist on a mountain, flight may be generally prevented by the mountain irrespectively of whether or not there are power lines.

Optionally, one or more zones are designated as prohibited photography zones, where drones are prohibited from photographing. For example, zones having a possibility of breach of privacy, and zones having sensitive military installations.

At 206, a flight safety score is assigned to each respective zone. The flight safety score is designated from multiple available flight safety scores, based on the presence of at least one existing object type within the respective volume. Optionally, a set of rules maps each object type to a certain flight safety score. The set of rules may be based on physical reality (e.g., can't fly through a mountain) and/or on policy, such as government defined drone flying policy (e.g., drones are not allowed to fly within 100 meters of high rise buildings).

Not necessarily limiting examples of zones with respective examples of a set of rules for assigning flight scores to the zone include:

Zones containing one or more infrastructure objects impermeable to flight, and/or having land terrain impermeable to flight may be assigned a score representing that flying through the zone is impossible, for example, an impossible flight score. For example, zone 1116 containing a large hill is designated with the impossible flight score.

Zones containing prohibited drone flight regions (permanent or temporary) may be assigned a score representing prohibited flight through the zone, for example, the impossible flight score, or a prohibited flight score. For example, zone 1118 containing an airport is designated with the prohibited flight score (or impossible flight score).

Zones containing dynamic object(s) may be assigned a dynamic score representing the risk of flight through the zone when the drone is flying through the zone or expected to fly through the zone. For example, zone 1120 is known to host a hot air balloon festival during a certain week of the year. The score for zone 1120 may be dynamically changed to high risk when the festival is on, and to low risk when the festival is not running. In another example, zone 1122, which used to be open land, is undergoing construction. The score for zone 1122 may be changed from low risk to high risk. Other examples of dynamic zones include zones having factors and/or objects such as: weather conditions, temporary air traffic (e.g., police helicopter chase of a vehicle), changes in flight policy, and event in a park.

Zones containing static object(s) may be assigned a static score. The static score may represent the risk of flight through the zone, to keep the drone away from the static object. For example, the risk of flight may increase closer to the object. For example, zone 1124 contains residential buildings. The score may represent a low risk of flight at 100 meters and further away from the buildings, increasing (e.g., gradually, exponentially, continuously, and/or step-wise) in closer proximity to the building. Other examples of static objects include: commercial warehouses containing flammable materials, and power lines.

For each zone, the set of rules mapping the data within each zone to flight risks, for example, starting from minimal risk flight zone, through optional different levels of risk, to high risk zone, and up to no flight zone. For example, the zone may be a function of wind speed, in which mild or no wind is associated with minimal risk, gradually increasing in score correlating with increase in wind speed, until high risk is assigned to wind speeds that would cause the drone to lose control and/or crash. In another example, the score may be based, for example, on the probability of the drone crashing into an object in the zone, which may be calculated using an estimation model and/or based on empirical collected data. For example, the risk of the drone navigating through valleys and/or canyons represented as a function of the distance of the drone from the hill and/or cliff face.

Optionally, zones designated as camera prohibited zones are assigned a score representing prohibited photography based on the set of rules. Drones without cameras may be allowed to fly through the zone (when the zone is otherwise safe for flying). Drones with an onboard camera may be allowed to fly through the zone when the onboard camera is shut off.

At 208, a flight risk map of the geographical air space is generated based on the defined volumes, where each volume is associated with a certain flight safety score.

The map may include zones designated as impossible flight and/or zones having prohibited flight, to generate a complete picture of the environmental air space. Such zones are assigned appropriate scores, to generate a map where flying is possible.

At 210, the flight risk map for navigation of the drone(s) through the geographical air space is provided. The map may be, for example, stored (e.g., for future updates), transmitted and/or made available for remote access (e.g., when the control server is at a remote location), and/or locally provided for processing by other modules (e.g., when the map generator and control server are integrated as a single unit).

Optionally, at 212, updates are received. Updates may be received for one or more of: the received data (block 202), instructions on dividing the geographical air space into zones (block 204), the set of rules for assigning scores to the zones, and updated policy on which the set of rules is based. Updates may be managed by a dynamic flight zone server 105 stored on or in communication with control server 1108. Dynamic flight zone server 105 may update respective flight zone risk scores to reflect changes in parameters, such as dynamic parameters, for example, weather.

Optionally, the set of rules is dynamically changed. Different scores may be assigned for different conditions. The set of rules is dynamically changed, for example, based on time of day, day of the week, holidays, and festival day. For example, drone flying may be allowed in certain areas of the city during the night, but prohibited during the day. In another example, drone flying may be prohibited over parks during the weekend (when many people are expected) but allowed during weekdays (when fewer people are expected).

When updates are received, affected zones may be updated, sections of the map, or the entire map may be updated, by iterating blocks 202-210.

Optionally, policy updates are initiated by the flight authorization authority from authorities policy and rules server 104B, for example, uploaded to policy server 104 of the control server for implementation within the local geographical air space. The set of rules is updated based on the updated policy. The policy updates may include the updated set of rules. In this manner, the updated set of rules may be automatically received and automatically implemented.

Examples of policy update types include:
Updating given parameter(s) of the current policy (e.g. change risk level for a given zone type, e.g., object and/or infrastructure type).
Changing the category and/or characteristics of a given object type (e.g., infrastructure type), for example, for commercial warehouses adding a flammability characteristic and/or assigning a new policy for risk flight risk level accordingly.

The policy update server 104 may accept and/or validate the requested change, and update a policy database (in communication with server 104). Server 104 may trigger recalculation of the risk assessment score assignment (block 206).

Optionally, different policy sets may be stored for use within a given controlled area. The different policies in the set may be dynamically selected, for example, changing respectively between day time and night time flight policy sets depending on the time of day.

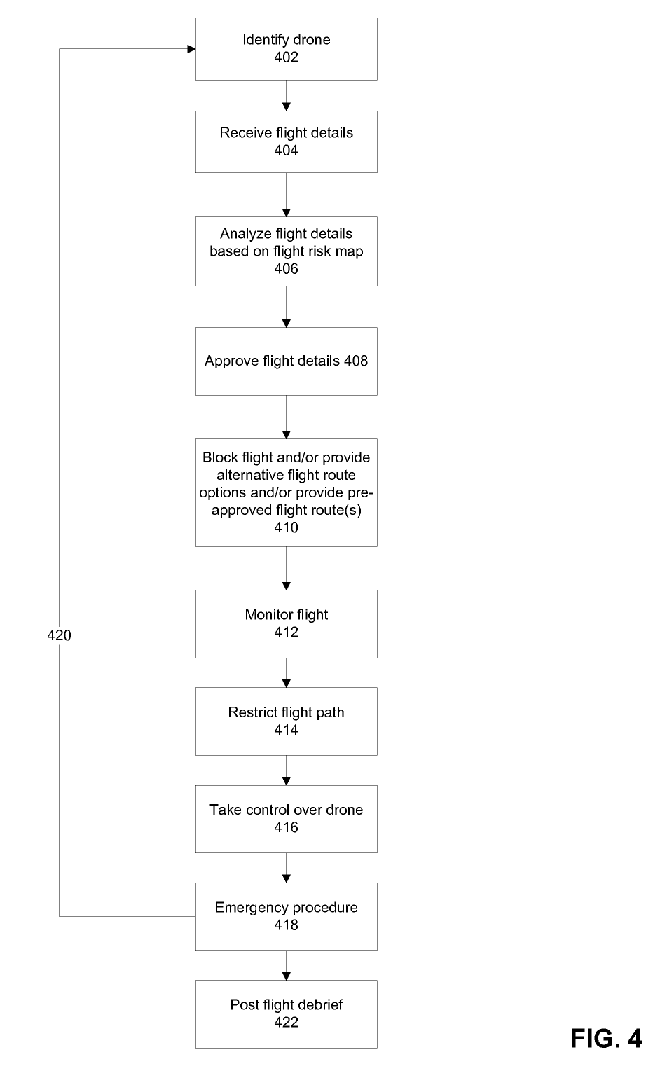

Reference is now made to FIG. 4, which is a flowchart of a computer implemented method for safe navigation of drones through designated air zones based on a flight risk map, in accordance with some embodiments of the present invention. The flight risk map may be generated based on the method described with reference to FIG. 2. The safe navigation may be controlled by central control server 1108 of FIG. 1, using the system architecture of FIGS. 3A-3B.

The method may help ensure that certified drones, after take-off from an uncontrolled air space, do not enter controlled air space without an approved flight plane and/or valid certification.

Communication with the drone may be handled by an external operator communication server 111 stored on, or in communication with control server 1108. Communication server 111 may perform, for example, receiving a request for a pre-approved route from the drone, receiving a request to approve a drone operator proposed route, sending the approved route data to the drone, communication of in-flight status reports, and/or other communications, for example, as described herein.

Optionally at 402, one or more drones flying within or in proximity to a geographical air space are identified. The drone may initiate contact with the central control server, and/or the central control server may detect the presence of the drone, for example, using radar, and/or by listening on a certain frequency band to data transmissions of the drone.

Optionally the drone is identified based on a registered identification, for example, by obtaining the identification code from the drone and looking up the code in a drone registration and/or performance server 112 in communication with control server 1108. Server 112 may handle the data relevant to drones, for example, certification data (e.g., certification type, expiration date), flight data (e.g., max climb rate). Server 112 may store real-time in-flight data, including nominal and/or actual drone parameters. The estimated arrival time to the borders of the no flight regions defined by the flight risk map is calculated, and action is taken accordingly to prevent the drone from reaching the borders, by either re-navigating the drone or automatically taking over navigation of the drone by the central controller.

New drones may undergo a registration process, in which each drone is assigned drone module 1104 associated with a unique identifier. As part of the registration process, drone related data (e.g., drone performance parameters, gross weight, maximum speed, climb rate, maximum flight range, maximum tolerated wind speeds, and/or certification data such as flight license expiration date) may be obtained and stored in association with the drone identifier, for example, stored in a drone identification database in communication with the control server. Some or all of the registration details (e.g., expiration date) may also be stored in the drone module itself. The onboard data may be provided to one or more respective control centers as the drone travels. The drone registration may be transmitted to the control center after undergoing approval and/or encoding by an authority, for example, a flight certification authority. The details of each drone (e.g., flight permit renewal) may be updated periodically and/or when available.

The drone may be identified before take-off (e.g., based on a flight plan that designates one or more air routes through the air space), before entering the geographical air space (e.g., the drone requesting permission to fly through the air space), and/or once the drone has entered the geographical air space.

Drone start up and/or take off may be initiated by the drone operator, by the drone itself, and/or by one or more control servers encountered en route. After start up, the drone module may check whether the drone has obtained a valid flight authorization and/or certification. The drone module may prevent drone take off when no authorization is found, and/or when the authorization is invalid. The control center may provide the drone module with the pre-approved flight plan, and/or approved a propose plan (as described herein). When no flight plan has been authorized for the drone, the drone may be prevented from taking off by the onboard module and/or the control server.

At 404, flight data representing a certain flight path of the drone through the geographical air space is received by the central server. The flight data may be provided by the drone itself, or by another entity, such as an organizational server of the organization controlling the drone.

The flight data may include in-flight data when the drone is in flight, in proximity to the air space, or while in the air space. Alternatively or additionally, the flight data includes a proposed flight plan, such as before the drone takes off, or before the drone enters the air space.

Optionally, one or more of the following data items are recorded at the control center, to be made available for future analysis and/or retrieval, for example: commands sent from the control server to the drone, actual drone flight data (e.g., latitude, longitude, and/or altitude as a function of time), drone built in test status reports (e.g., malfunctions), and drone deviations from planned flight route.

At 406, the flight data is evaluated by the control server based on the flight risk map, (e.g., generated based on the method described with reference to FIG. 2) to determine the flight risk of the received flight path of the drone through the geographical air space.

Optionally, when the flight data includes a request for a flight plan (instead of the drone presenting a proposed flight plan), the control server generates a pre-approved flight plan for the drone within the acceptable risk threshold. The pre-approved flight plan may be based on the evaluated flight data, for example, taking into consideration parameters such as the current location of the drone, the target destination, and drone performance capabilities.

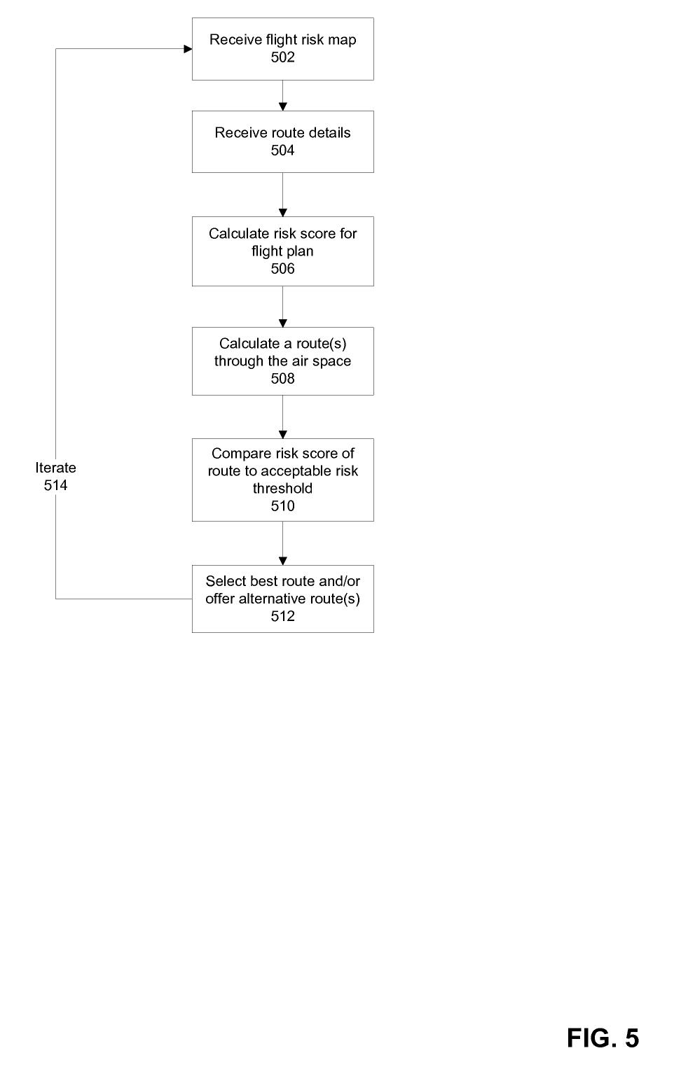

Reference is now made to FIG. 5, which is a flowchart of a computer implemented method for analyzing drone flight details through the geographical air space based on the flight risk map, in accordance with some embodiments of the present invention. The analysis method performs one or more of the following functions: evaluate a flight plan of a drone for safe flying through the air space, provide a pre-approved flight plan for the drone, and/or propose an alternative flight plan for the drone. The method of FIG. 5 may be implemented by control server 1108, for example, by drone monitoring module 304.

The method described with reference to FIG. 5 determines whether an externally generated flight plan may be approved, based on one or more of: current policy, dynamic flight zones, previously approved flight plans for other drones, forecasted weather, and/or other factors described herein.

The method determines the risk of flying on one or more routes, and approves the route based on a certain accepted risk threshold. The method may suggest alternatives, for example, lower risk routes and/or shorter routes which may have a similar risk level as the original route.

At 502, the flight risk map, as described herein, is received. Optionally, the most recently updated version of the flight risk map is received. Alternatively, the flight risk map is updated.

At 504, flight route details are received at the central command server. Optionally, the flight route details include a proposed flight plan (complete or partial) through the air space. The flight route details may be provided directly by the drone, such as transmitted by the drone module to the central command server, and/or through an external server in communication with the drone, such as a server of the company that operates the drones. Alternatively or additionally, the flight route details are received from the drone operator (e.g., ground based drone company server), for example, through ground based communication (e.g., the internet).

One or multiple flight plans may be submitted. Multiple flight plans may be submitted, for example, when the drone is unsure of which flight plan is designated as a safe flight through the air space. Alternatively or additionally, the flight route details include a request for a pre-approved flight plan (complete or partial).

The complete plan may include a complete flight route for the drone to travel through the air space, land in the air space, or take off from the air space. The partial plan may include one or more flight segments in the air space.

The flight plan may include details of the path of the flight through the air space. Alternatively, the flight plan includes an entrance point into the geographical air space, and an exit point out of the geographical air space, without necessarily providing details of the flight path within the air space.

Additional details related to the flight plan include, for example, one or more of: requested flight times, drone identification, payload type (e.g., hazardous material, personal packages, camera, restricted materials), weather data, and/or safe landing sites.

Optionally, drone flight performance details are accessed or received. The details may include static drone parameters, for example, drone weight, maximum flight speed, and maximum altitude. The details may include real time in-flight performance, for example, current total weight (i.e., drone weight including on-board packages), current flight speed, current altitude, current flight direction.

Optionally, at 506, when the drone proposes the flight plan, one or more risk scores are calculated for the flight plan based on the flight risk map. For example, a total risk score may be calculated based on scores of respective zones the drone is proposing to fly through. In another example, each zone the drone is proposing to fly through is individually evaluated, to identify zones where the drone is not allowed to fly through (e.g., high risk zone, restricted zone, physical barrier zone).

Alternatively or additionally, at 508, when the drone requests the flight plan from the central control server, the server calculates one or more flight routes through the geographical air space based on the flight risk map. Each flight plan may have a calculated total risk score based on the flight risk map, calculated based on the zones in the flight path. Each flight plan may be built based on air segments that do not traverse certain zones, for example, avoiding high risk zones, restricted zones, or physical barrier zones.

The flight plan may be generated, for example, based on a search algorithm, which weighted by the risk factors in the dynamic flight zones map, generates a legal (i.e., policy following), minimum risk route.

Planning of routes may be performed, for example, by a route planning server 110 stored on, or in communication with control server 1108.

At 510, the flight plan proposed by the drone and/or each flight plan generated by the server are evaluated. The respective flight plan is approved or rejected. The approval or rejection may be performed by comparing the total calculated risk of flight to a predefined total risk threshold. When multiple flight plans are proposed, a subset of one or more flight routes with acceptable total flight risk is designated. The approval or rejection may be performed by checking whether a portion (or all) of the flight plan involves flying through certain zones. For example, a flight plan that flies only through low risk zones is approved. In another example, a flight plan that includes a short flight segment through a restricted zone is denied.

Optionally, at 512, when multiple flight plans have been proposed by the drone, and/or multiple flight plans have been generated, one or more routes are selected from the subset of safe and/or pre-approved flights. The most optimal routes may be selected, for example, based on an optimization of total flight risk and total flight length. For example, shorter flight paths being preferred over long flight paths when risk is similar. For example, longer flight paths being preferred over shorter flight paths when risk of the shorter flight is higher than risk of the longer flight.

Optionally, when none of the drone proposed flights have been approved, the server may calculate one or more alternative pre-approved flight routes. Alternative flight routes may be calculated to try and identify flight route that are more optimal than the previous identified routes, such as when the drone requested a flight route and/or when the drone proposed the flight route.

The alternative flight routes may be calculated based, for example, on one or more dynamic parameters that affect the flight risk score of one or more zones of the air space, for example: to fly at a different time of day, to fly at a different day of the week, and to wait until current weather conditions have passed.

Optionally, at 514, one or more blocks 502-512 are iterated, to generate an updated flight plan. The updated flight plan may be a revision of the previous plan, or a new plan. The flight plan may be dynamically updated, such as in real time, for example, in view of sudden changes in conditions, for example, closing off of air zones due to a terrorist attack, changes in flight risk due to an onset of a storm, and changes in flight risk due to an increase in the number of drones flying through one or more zones of the current flight plan.

Referring now back to FIG. 4, optionally, at 408, the proposed flight path is approved by the control server when the flight risk of the drone is within an acceptable risk threshold, for example, when the risk of crash is below the threshold. The flight risk may be calculated as a cumulative risk of flight based on all (or a subset of) zones the drone is expected to fly through. In another example, the path is approved when each zone the drone flies through is below the acceptable risk, for example, the drone is expected to fly only or mostly through zones designated as low risk.

Alternatively, at 410, when the proposed flight path is not approved by the control server, the flight path is rejected or blocked. The flight path may be rejected or blocked when the flight risk of the drone is outside the acceptable risk threshold. In such a case, the control server may request a new flight plan, and/or calculate one or more allowed flight paths for the drone, as described herein. The drone may navigated or be navigated based the allowed flight paths, as described herein.

At 412, the drone is monitored by the control server during the flight through the air space. The drone may be monitored based on monitoring the flight data of the drone transmitted to the central server during the flight within the geographical air space.

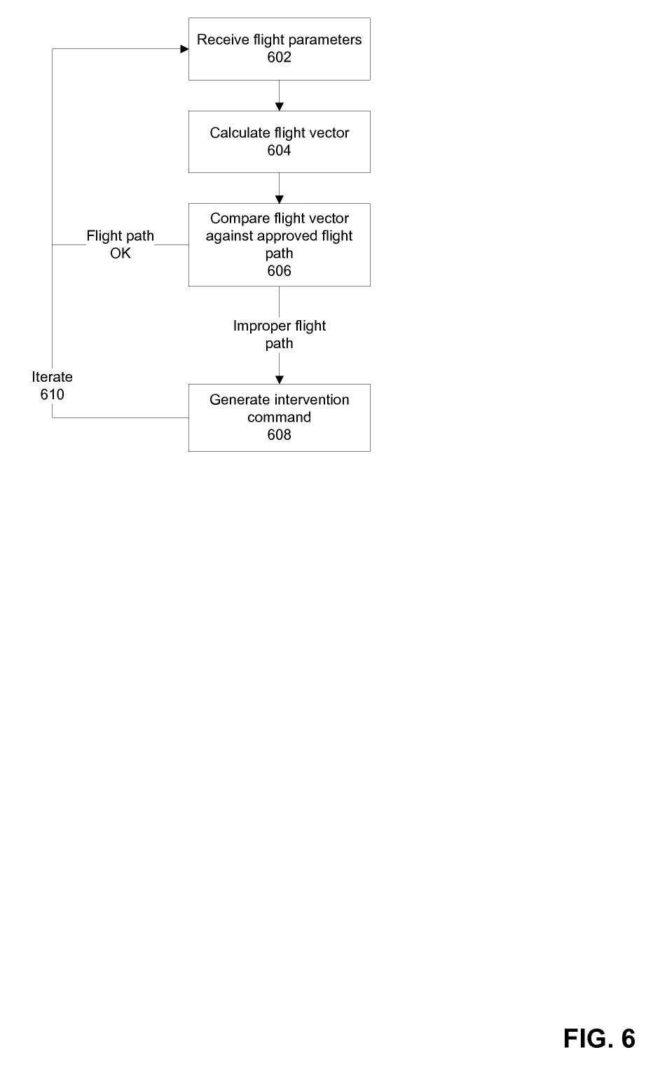

Reference is now made to FIG. 6, which is a computer implemented method for monitoring flight of a drone through a geographical air space based on a flight risk map, in accordance with some embodiments of the present invention. The method monitors flight data of the drone within the geographical air space. The flight data is compared against a flight route and/or the flight risk map, to determine whether the drone is flying within, or predicted to fly into a restricted or a high risk flight zone. The method of FIG. 6 may be implemented by control server 1108, for example, by drone monitoring module 304.

At 602, real time flight parameters are transmitted from the drone to the central control server, for example, direction of flight (e.g., in three dimensions), speed of flight, and altitude.

At 604, a flight vector path of the drone is calculated based on the flight data. The calculation may be performed by the central server. The flight vector is calculated to provide an estimate of the current and/or near future location of the drone within the air space, for example, the current real-time location of the drone, the estimated location of the drone in about 5 seconds, about 10 seconds, about 30 seconds, about 1 minute, or other smaller, intermediate, or larger time frames.

At 606, the current and/or near future estimated location of the drone in the air space is evaluated. The current and/or estimated location of the drone may be compared with the proposed flight plan, to determine when the drone is located or estimated to be located outside of the proposed flight plan path. The current and/or estimated location of the drone may be compared with the proposed flight plan, to determine when the drone is located within, or estimated to fly into a certain zone having an unacceptable risk level, for example, above a threshold, an impassable zone, a high risk zone, and/or a restricted zone.

The current and/or estimated location of the drone may be compared with the flight risk map to determine when the drone is located within, or estimated to fly into a certain zone having an unacceptable risk level, for example, above a threshold, an impassable zone, a high risk zone, and/or a restricted zone. The comparison with the flight risk map may be made, for example, in a case when the flight risk map has been updated based on dynamic conditions, without yet updating the corresponding flight plan.

It is noted that the drone may obey the server approved flight plan, yet still find itself in an unacceptable zone. For example, the flight risk of the zone the drone is flying within (or expected to reach) may be dynamically adjusted from low risk to high risk, such as due to an unexpected presence of a police helicopter chasing a suspect, sudden onset of a storm, and a terrorist attack.

Optionally, at 608, when the drone is located within or estimated to fly into an unacceptable zone, the server takes action to prevent or correct the situation. The server may send a command to the drone to perform, for example, one or more of:
Hover in place, for example, when the server is unable to find a way to let the drone fly further, and conditions preventing the further flight are expected to change in the near future to allow flight to resume.
Perform an emergency landing, for example, when the flight path of the drone cannot be corrected, and/or where the drone is in a location of high risk of crash or damage.
Change flight route, for example, to remain within or enter a zone with an acceptable risk level.

At 610, the drone is iteratively monitored. When the server changes the flight plane of the drone, the drone is monitored for compliance with the new plan.

In an example, when the drone is unable to (or does not) follow the flight plan, the drone module may report the problem to the central control server, to trigger recalculation of the flight plan. The new flight plan may take into account actual drone performance data, as opposed to drone performance listed in the drone registration & performance center. When the drone is unable to (or does not) follow the new flight plan more than a predefined number of times, the drone may be forced to land at the closest landing site and/or told to return to base, for example, as described herein.

Referring now back to FIG. 4, optionally, at 414, the flight path of the drone may be restricted by the server. The drone may be restricted to navigate within certain allowed regions of the geographical air space based on the flight risk map, to maintain the drone within zones of the geographical air space having an acceptable flight risk. Within the allowed region, the drone may be provided with flight autonomy. For example, in a certain suburban region, the drone may be allowed to fly in a self-directed manner, as long as the drone does not fly close to a local small airport.

Optionally, at 416, control of the drone may be acquired by the local control server. Autonomous control of the drone may be relinquished, or control of the drone may be seized by the local control server. The control server may send a message to the drone operator (e.g., through an external operator communication server) indicative of the transfer of control. The control of the drone may be implemented by, for example, by drone controller module 306.

Control may be transferred permanently to the server, for example, when an emergency landing is required. Control may be temporarily transferred to the server and then returned to the drone, for example, to correct small deviations from the flight plan.

Voluntary control may be transferred from the drone to the ground server, for example, when the drone enters the local geographical air space, the drone may relinquish control to the ground control server, to let the server navigate the drone through the local air space. Autonomous control may revert back to the drone when the drone is leaving the local air space. In this manner, drones may be safely flown through respective local air spaces, based on local control. The local control may increase compliance with safety regulations, for example, instead of relying on the on-board computer of the drone to follow instructions.

The autonomous control of the drone may be taken over by the ground server, for example, when the drone does not follow the approved flight plan, when the drone entered a restricted air space, and when the drone has not responded to an updated flight plan.

The drone may be navigated by the local control server, automatically by a software module, and/or manually by a human pilot operating through a remote control unit.

The navigation may be performed, for example, through the drone module based on messages received from the group server. The drone module may issue fly-to commands, where each command indicates, for example, target point and/or desired speed, for each route leg.

Drone landing may be handled by the drone itself and/or by the drone operator, instead of by the control server. Returning navigation control back to the drone for landing may limit liability of the control server, for example, in case of a crash upon landing. The control server may guide the drone to the requested landing point (or outside of the air space region controlled by the control server), optionally at a pre-defined altitude, optionally with a command to hover in place. A message may be sent to the drone operator indicating the drone is ready to be landed, or, on capable autonomous landing drones, a land-here command may be issued from the server to the drone.

Optionally, at 418, emergency procedures are initiated, and/or preventive procedures are initiated.

One or more of blocks 414, 416, and 418 may be implemented by an autonomous drone air traffic controller 120 stored on or in communication with control server 1108. Drone controller 120 may operate in real-time, generating navigation control commands to drones in flight, as described herein. Controller 120 may receiving output of a drone tracker module to tag drones that are not following their flight plans, and optionally performs the appropriate corrective action, for example, generating a new route (e.g., using the route generation server) and uploading the new route to the drone, and/or initiating a forced landing sequence, as described herein.

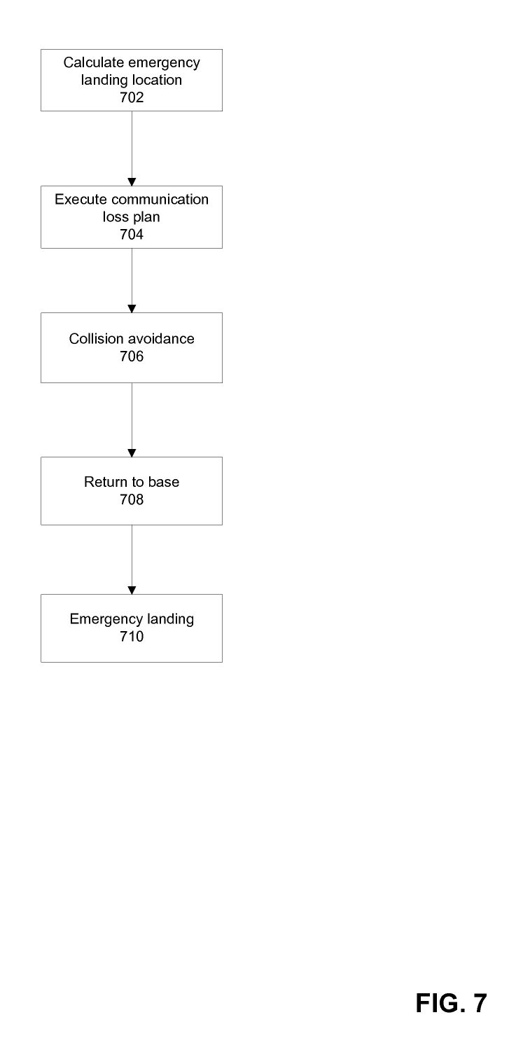

Reference is now made to FIG. 7, which is a flowchart of a computerized method for emergency and/or accident preventive procedures for the flying drone, in accordance with some embodiments of the present invention. The method performs one or more of the following functions: identifies safe emergency landing locations based on the flight risk map, executes a communication loss plan, collision avoidance, issues return to base command, and commands an emergency landing. The method of FIG. 7 may be implemented by control server 1108, for example, by drone controller module 306.

Optionally, at 702, one or more emergency landing locations are identified and/or designated for the drone based on the flight risk map, optionally in view of the proposed flight plan. The one or more emergency landing locations may be pre-designated as safe drone landing locations, and/or may be locations having other purposes that are determined to be safe for an emergency drone landing, for example, a public park with open space, a sparsely used rural road, a lake, and a flat apartment rooftop.

The emergency landing locations may be selected in advance, based on the approved flight plan, and/or in real-time based on the current and/or predicted location of the drone.

The server may dynamically select the safest flights paths from the current location of the drone to nearby safe landing locations, for example, when the drone is unable to land in the current zone the server may navigate the drone to nearby zone having a safe landing location. The safe emergency landing paths may be dynamically updated during flight of the drone. In such a manner, a safe contingency plan may be available for the drone to follow across the flight path.

The list of safe landing locations may be prioritized, for example, according to drone operator preference.

Alternatively or additionally, at 704, the drone is provided with a communication-loss flight plan to execute when communication has been lost between the drone and the central server. The communication-loss flight plan may be automatically executed by the drone when communication between the drone and the server has been lost, for example by a communication loss module installed on the drone. The communication-loss flight plan may be automatically executed, for example, when messages transmitted by the control server have not been received by the drone after a predefined period of time.

The drone may periodically send a self location message to the control server, and wait for the control server to respond with an acknowledgement or a specific command (e.g., change route). When the drone does not receive the expected response after a predefined period of time, the drone may initiate a communication loss procedure that first tries to re-establish the communication loss by re-transmission of the self location message. A communication flight plan may then be followed.

The communication-loss flight plan may allow the drone to continue flying within a dedicated communication loss route, and/or land in a safe autonomous manner within the geographic air space, without navigation assistance from the control server. The communication loss plan may be defined based on government and/or local policy.

Communication loss may occur, for example, due to interference, due to attempts at interference with the communication signals, and due to communication equipment failure.

Alternatively or additionally, at 706, the drone is provided by the central server, with collision avoidance assistance to avoid mid-air collision with other drones. The collision avoidance may be executed in conjunction with the flight analysis (e.g., block 406 of FIG. 4) as part of the flight path approval and/or generation process. The collision avoidance method may be implemented by a drone tracker and/or collision avoidance module 121, which tracks actual drone reports and/or generates track data from the repots. Module 121 may generate an alert when the drone is now following the correct path. Module 121 may perform drone position prediction to evaluate risk of mid air collision.

The server may receive flight plans of drones, current location of drones, and/or expected location of drones, within the air space. The server analyzes the data to identify a risk of collision between two or more of the drones, for example, due to a crossover of flight paths, and/or a faster drone travelling behind a slower drone. The risk of collision may be calculated based on a distance between two drones currently or scheduled to be smaller than a predefined threshold.

The server may generate a message indicating the risk of collision and/or take action to reduce and/or prevent the collision. Optionally, the server triggers an adjustment of the one, some, or all of the flight plans of the at risk drones, to reduce or prevent the risk of collision. For example, a new route is calculated for one or both drones to avoid the risk of collision. Alternatively or additionally, the server issues navigation instructions to one or more of the drones, and/or takes control of one or more of the drones, to avoid or reduce the risk of collision without adjustment of one or more of the respective flight plans. For example, one drone is instructed to hover in place while another drone passes.

When communication with the drone has been lost, the control center may calculate an estimated drone location (e.g., based on the communication loss flight policy), which may include a margin of safety around the predicted location.

Alternatively or additionally, at 708, the drone is instructed to return to its base. The drone may be instructed to return, for example, when a safe passage through the geographical air space cannot be identified, for example, no safe passage is currently available due to an air show over the city, no drone are allowed to fly over the city during the day, the drone does not have enough fuel left to fly through the designated safe passage, and/or the drone is unable to complete its flight safely (e.g., weather conditions changes that do not allow the drone to land at its target destination).

The control server may calculate the return to base route (e.g., based on the method described with reference to FIG. 5), and transmit the route to the drone.

Alternatively or additionally, at 710, the drone is instructed to perform an emergency landing. The drone may be forced to land when the risk of continuing the planned flight exceeds a predefined threshold. Optionally, the landing sites are stored within a landing site database stored on, or in communication with control server 1108.

The emergency landing may be trigged, for example, based on identification of a scenario of unavoidable drone loss (e.g., engine failure), insufficient fuel and/or battery to reach target destination, dynamic factors changing the risk status of the current zone of the drone (e.g., storm), failure to follow the flight path, the drone flying into a restricted space, and a need to pause the flight plan (e.g., weather conditions) without returning to home base.

The emergency landing may be controlled, for example, by a damage reduction module stored on or in communication with control server 1108, which attempts to reduce damage due to a scenario of unavoidable drone loss.

In another example case, when the control server and/or the drone module detects that the drone is deviating from the flight plan (e.g., in terms of time to waypoint), the drone module may request an updated flight plan. When the drone fails to meet the requested flight plan, for example, more than a predefined number of times, the drone may be forced to land.

The drone may be provided with a reduced damage route to land the drone. The reduced damaged route is selected to land the drone while minimizing drone damage based on navigating the drone through low risk zones, and/or minimizing travel through high risk or restricted zones. The reduced damage route may be provided in advance to the drone as a contingency plan, and/or provided in real time.

The drone may be navigated through the reduced damage route until the drone lands, autonomously or under the ground based central server control (automatically or manually).

The drone may transmit a message to the control server when the forced landing process has been initiated, and/or a message after the drone has landed.

Referring now back to FIG. 4, at 420, one or more blocks 402-418 may be iterated, to maintain safe flight of the drone. The iterations may be performed to implement dynamic changes of the flight data and the flight risk map, as described herein. Optionally, changes to the risk associated with one or more flight zones may trigger an update of the flight map and/or an update of one or more affect flight plans of one or more drones.

The blocks may be iterated for every new drone flight.

Optionally, flight routes are modified when the difference between the current route and a new route based on an updated map, is greater than a minimum route change threshold, for example, when one or more zones in the path of the drone have been newly designated as restricted air space.

Optionally, one or more blocks are iterated to provide in flight route updates. The updates may be trigged, for example, based on a dynamic flight zone risk change, and/or an alert from the drone tracker & collision avoidance process. The update may be uploaded to the drone by the control server. Upon receipt of the new plan, the drone replaces the current flight plan with the new plan.

Drones travelling large distances may encounter multiple different control servers, each serving a local geographical air space. Each control server may operate independently, triggering one or more blocks 402-418, to safely navigate the drone within the location air space.

Optionally, at 422, data collected in association with the drone flight is analyzed as a post flight debrief. Post mission debrief may include evaluation of actual flight data as compared to the flight plan. Accumulated data may be used for maintenance and/or drone calibration. A data recorder module 140 stored on or in communication with control server 1108 may record actual flight data for each drone, which may be used for playback and/or for the debrief. A playback and debrief module 141 stored on or in communication with control server 1108 may access module 140 to automatically perform most mission debriefs to detect anomalies in flight performance.

The collected data may enable location of lost drones based on the last known location.

Data may be analyzed in case of an accident, for example, to help recreated the accident environment.

The data may be compiled over multiple drone flights of the same drone, and/or complied from multiple drone flights of different drones, to analyze trends in drone performance (for a specific drone and/or for a drone type).

The methods as described above may be used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant drones will be developed and the scope of the term drone is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computer implemented method for navigation of a drone through a geographical air space, the method comprising:
identifying a drone within or in proximity to a geographical air space;
receiving from the drone, flight data representing a certain flight path of the drone through the geographical air space;
evaluating the flight data based on a flight risk map to determine the flight risk of the certain flight path of the drone through the geographical air space, wherein the flight risk map of the geographical air space includes a plurality of zones, each zone being associated with a certain flight safety score; and
at least one member of the group consisting of:
approving the certain flight path when the flight risk of the drone is within an acceptable risk threshold,
blocking the certain flight path when the flight risk of the drone is outside the acceptable risk threshold, and
obtaining external control of navigation of the drone to navigate the drone through at least one zone having the acceptable risk threshold.

2. The method of claim 1, further comprising:
acquiring automatic or manual control of the drone by a local drone control server; and
navigating the drone within the geographical air space based on the evaluated flight path.

3. The method of claim 1, further comprising generating a flight plan for the drone within the acceptable risk threshold based on the evaluated flight data, and navigating the drone within the geographical air space based on the generated flight plan.

4. The method of claim 1, further comprising monitoring flight data of the drone during flight within the geographical air space, and iterating the evaluation based on dynamic changes of at least one of the flight data and the flight risk map.

5. The method of claim 1, further comprising restricting navigation of the drone to within certain regions of the geographical air space based on the flight risk map, to maintain the drone within zones of the geographical air space having an acceptable flight risk defined by a risk threshold.

6. The method of claim 1, further comprising:
receiving details of a requested route from at least one of the drone and a ground based drone operator;
calculating at least one flight route through the geographical air space based on the flight risk map, the at least one flight route calculated to have a total low risk of flight based on the flight safety scores of respective zones of the geographical air space;
comparing the total low risk of flight to a predefined total risk threshold to designate a subset of at least one flight route with acceptable total flight risk; and
selecting an optimal route from the subset based on a optimization of total flight risk and total flight length.

7. The method of claim 1, further comprising:
receiving details of a flight plan from at least one of the drone and a ground based drone operator;
calculating a total risk of flight of the flight plan through the geographical air space based on the flight risk map, the total risk of flight calculated based on the flight safety scores of respective zones of the geographical air space within the flight plan;
comparing the total low risk of the flight plan to a predefined total risk threshold to approve or deny the flight plan; and
providing an alternative calculated flight route having a total risk below the threshold, when the flight plan is denied.

8. A system for navigation of a drone through a geographical air space, the system comprising:
a drone communication interface configured to transmit data to at least one drone and receive data transmitted by the at least one drone;
a central drone control server in communication with the drone interface, the server configured to:
identify a drone within or in proximity to a geographical air space;
receive from the drone, flight data representing a certain flight path of the drone through the geographical air space;
evaluate the flight data based on a flight risk map to determine the flight risk of the certain flight path of the drone through the geographical air space, wherein the flight risk map of the geographical air space includes a plurality of zones, each zone being associated with a certain flight safety score; and
performing at least one member of the group consisting of:
send a message to the drone indicating approval of the certain flight path when the flight risk of the drone is within an acceptable risk threshold,
send the message to the drone indicating blockage of the certain flight path when the flight risk of the drone is outside the acceptable risk threshold, and
obtain external control of navigation of the drone to navigate the drone through at least one zone having the acceptable risk threshold.

9. The system of claim 8, further comprising:
a server interface configured for installation on the at least one drone and to transmit data to the server and receive data transmitted by the server;
a drone module configured for installation on the at least one drone, the drone module in communication with the server interface, the drone module configured to generate flight data of the drone through the geographical air space.

10. The system of claim 9, wherein the drone module is configured to relinquish navigation of the drone to the central server.

11. The system of claim 10, wherein the central server controls the navigation of the drone by transmitting and receiving within a predefined frequency band.

12. The system of claim 8, wherein the central drone control server further comprises a registration module configured to receive registration data of a new drone and store the registration data, the registration data including at least one of: a unique identifier and drone performance data.

13. The system of claim 8, further comprising a flight monitoring module in communication with the control server, the flight monitoring module configured to:
calculate a flight vector path of the drone based on the flight data;
estimate the flight of the drone based on the flight vector to determine when the drone is estimated to fly into a certain zone having an unacceptable risk level above a threshold; and
send a command to the drone to at least one of: hover in place, perform an emergency landing, and to change direction to remain within at least one zone having an acceptable risk level below the threshold.

14. The system of claim 8, further comprising a communication loss module for installation on the drone, the communication loss module configured to:
receive a communication-loss flight plan to execute when communication has been lost;
monitor for messages transmitted by the control server; and
execute the communication-loss flight plan when messages transmitted by the control server have not been received after a predefined period of time.

15. The system of claim 8, further comprising a collision prevention module in communication with the control server, the collision prevention module configured to:
receive a plurality of flight plans of a plurality of drones;
identify a risk of collision between at least two of the plurality of drones; and
generate a message indicating the risk of collision and trigger adjustment of at least one of the flight plans of the at least two of the plurality of drones to reduce or prevent the risk of collision.

16. The system of claim 15, wherein the collision prevent module is further configured to calculate an estimated drone location when communication with one or more drones has been lost, the estimated drone location including a margin of safety around the predicted location.

17. The system of claim 8, further comprising a damage reduction module in communication with the control server, the data reduction module configured to:
identify a scenario of unavoidable drone loss;
plan a reduced damage route to land the drone while minimizing damage based on navigating the drone through low risk zones; and
navigate the drone through the reduced damage route until the drone lands.

18. A computer implemented method for generating a flight risk map of a geographical air space for navigation of a drone through the geographical air space, the method comprising:
generating a model dividing a geographical air space into a plurality of zones;
assigning a certain flight safety score to each respective zone of the plurality of zones in the model, the certain flight safety score designated from a plurality of flight safety scores based on at least one object within the respective zone and a set of rules mapping the at least one object to the certain flight safety score;
monitoring for dynamic changes to at least one of the set of rules and the at least one object;
updating at least one of the set of rules and the at least one object;
repeating the generating and the assigning; and
outputting a dynamically updated flight map based on the model.

19. The method of claim 18, wherein the set of rules includes:
designating respective zones containing at least one object impermeable to flight as an impossible flight score.

20. The method of claim 19, wherein the set of rules includes:
designating respective zones containing prohibited drone flight regions as the impossible flight score.

21. The method of claim 18, wherein the set of rules includes:
designating respective zones containing at least one dynamic object based on respective risk of flying introduced by the at least one dynamic object.

22. The method of claim 21, wherein the at least one dynamic object is selected from the group consisting of: weather conditions, air traffic, changes in flight policy, event in a park, a construction zone, and a hot air balloon flying zone.

23. The method of claim 18, wherein the set of rules includes:
designating respective zones containing at least one static object based on respective risk of flying into the at least one static object.

24. The method of claim 23, wherein the at least one static object includes at least one member selected from the group consisting of: high rise buildings, flammable commercial warehouse, and power lines.

25. The method of claim 18, further comprising designating at least one as a camera prohibited zone based on the set of rules defining the at least one object as a photography prohibited object.

26. The method of claim 18, wherein the dynamically changed is based on time of day.
